(19) United States
(12) Patent Application Publication
(10) Pub. No.: US 2025/0191220 A1
(43) Pub. Date: Jun. 12, 2025

(54) METHOD AND ELECTRONIC DEVICE FOR DETERMINING RELATIVE POSITION OF ONE OR MORE OBJECTS IN IMAGE

(71) Applicant: SAMSUNG ELECTRONICS CO., LTD., Suwon-si (KR)

(72) Inventors: Navaneeth PANTHAM, Bengaluru (IN); Aravind KADIROO JAYARAM, Bengaluru (IN); Swadha JAISWAL, Bengaluru (IN); Vishal Bhushan JHA, Bengaluru (IN); Raghavan VELAPPAN, Bengaluru (IN); Akhilesh PARMAR, Bengaluru (IN)

(73) Assignee: SAMSUNG ELECTRONICS CO., LTD., Suwon-si (KR)

(21) Appl. No.: 19/054,169

(22) Filed: Feb. 14, 2025

Related U.S. Application Data
(63) Continuation of application No. PCT/KR2023/095048, filed on Aug. 23, 2023.

(30) Foreign Application Priority Data
Aug. 23, 2022 (IN) 202241047916
May 11, 2023 (IN) 202241047916

(51) Int. Cl. G06T 7/73; G06T 7/12; G06T 11/00

(52) U.S. Cl. CPC G06T 7/73; G06T 7/12; G06T 11/00

(57) ABSTRACT

A method may include: obtaining at least one semantic parameter associated with the image; segmenting the at least one object based on the at least one semantic parameter to generate a first segmented object and a second segmented object; identifying a camera level of the electronic device; applying a ground mesh to the image based on the camera level; determining placements of the first segmented object and the second segmented object based on the at least one semantic parameter associated with the first segmented object, the second segmented object, and the ground mesh; determining a relative position of the first segmented object with respect to the second segmented object based on the determined placement of the first segmented object and the second segmented object; and displaying the at least one object on a screen of the electronic device based on the determined relative position.

### CROSS-REFERENCE TO RELATED APPLICATIONS

This application is a bypass continuation of International Application No. PCT/KR2023/095048, filed on Aug. 23, 2023, which is based on and claims priority to Indian Patent Application No. 202241047916, filed on Aug. 23, 2022, and Indian Patent Application No. 202241047916, filed on May 11, 2023, in the Indian Patent Office, the disclosures of which are incorporated by reference herein in their entireties.

### BACKGROUND

### 1. Field

The present invention relates to image processing, and more specifically related to a method and an electronic device for determining a relative position of one or more objects in an image.

### 2. Description of Related Art

Augmented Reality (AR) is a cutting-edge technology, with a significant increase in research pertaining to enabling an AR mode in electronic devices (e.g. smartphones, smart glass, etc.). Consider the following scenario where a user interacts with AR objects associated with an image/image frame(s) in the real world, which requires advanced occlusion techniques to provide a seamless experience to the user. However, most existing State-Of-The-Art (SOTA) occlusion techniques for obscuring virtual/augmented objects are limited to either a room scale or up to a certain limited distance, not covering the entire visible distance. Existing electronic devices or Head-mounted displays (HMDs) have a depth constraint in that electronic devices or H4MDs cannot detect the depth value of distant objects. As a result, existing AR experiences on the electronic devices are limited to the room scale.

To address the aforementioned challenge, most existing methods rely on hardware of the electronic device to measure distance and are capable of scaling up AR experiences. However, such expensive hardware is only found in a small percentage of high-end electronic devices. Despite this, scalability remains a challenge due to other hardware limitations, which limit the range of depth sensors. For example, existing electronic devices included Light Detection and Ranging (LIDAR), but the range is still limited to the room scale. Existing electronic devices/methods rely on hardware (e.g., depth sensors) to bring the AR experiences to a global scale. Furthermore, other non-hardware-dependent methods rely on visual semantic understanding and define occlusion relationships and depth ordering based on colour(color) variation, texture variation, and pixel variation.

### SUMMARY

Thus, it is desired to address the above-mentioned disadvantages or other shortcomings or at least provide a useful alternative for determining the relative position of one or more objects in the image/image frame in order to take these AR experiences to a larger scale without relying on the hardware.

Embodiments herein can provide a method for determining a depth and/or relative position of an object(s) associated with an image/image frame(s) based on an understanding of object geometry in perspective without relying on an electronic device's hardware (e.g., depth sensors). As a result, the proposed method may enable a variety of electronic devices to provide AR users with a world-scale enhanced experience.

Embodiments herein can also establish layering based on the object(s)-ground vanishing point(s) and object(s)-ground contact point(s). As a result, the proposed method can outperform existing methods. Furthermore, embodiments may take into account various slopes in terrain in the electronic device's field of view, extending its applicability to the world-scale scale and increasing the electronic device's efficiency/accuracy to layer the segmentation based on visual semantic understanding of ‘object geometry in perspective’ to create faux depth.

According to one or more example embodiments, a method of controlling an electronic device for determining a relative position of at least one object in an image, may include: obtaining at least one semantic parameter associated with the image; segmenting the at least one object based on the at least one semantic parameter to generate a first segmented object and a second segmented object; identifying a camera level of the electronic device; applying a ground mesh to the image based on the camera level; determining placements of the first segmented object and the second segmented object based on the at least one semantic parameter associated with the first segmented object, the second segmented object, and the ground mesh; determining a relative position of the first segmented object with respect to the second segmented object based on the determined placement of the first segmented object and the second segmented object; and displaying the at least one object on a screen of the electronic device based on the determined relative position.

The method further may include: determining at least one optimal location for at least one virtual object in the image based on the determined relative position of the first segmented object with respect to the second segmented object; and displaying the at least one object with the at least one virtual object on the screen of the electronic device based on the determined at least one optimal location.

The at least one semantic parameter may include at least one of: the at least one object within the image, an edge of the at least one object, a ground corner point of the at least one object, a boundary of the at least one object, or a ground intersection edge of the at least one object.

The determining the placements of the first segmented object and the second segmented object based on the at least one semantic parameter associated with the first segmented object, the second segmented object, and the ground mesh may include: determining ground corner points of the first segmented object and the second segmented object based on ground intersection edges of the first segmented object and the second segmented object; determining distances of the determined ground corner points to the camera level based on the ground mesh and the camera level; classifying the determined ground corner points as at least one of a near-ground corner point, a mid-ground corner point, or a far-ground corner point; and determining the placements of the first segmented object and the second segmented object based on the determined distances and the classified ground corner points.

The determining the relative position of the first segmented object with respect to the second segmented object based on the determined placements of the first segmented object and the second segmented object may include at least one of: comparing a distance of a near-ground corner point of the first segmented object with a distance of a near-ground corner point of the second segmented object; or comparing a distance of a far-ground corner point of the first segmented object with a distance of a far-ground corner point of the second segmented object.

The applying the ground mesh based on the camera level may include: applying the ground mesh covering an area of the image below the camera level.

The determining the distances of the determined ground corner points to the camera level based on the ground mesh and the camera level may include: determining the distances as perpendicular distances between the ground corner points and the camera level.

The determining the distances of the determined ground corner points to the camera level based on the ground mesh and the camera level may include: locating at corner points of the first segmented object and the second segmented object; determining intersection points of the located corner points with the ground mesh; and determining the distances as perpendicular distances between the corner points and the camera level.

The determining the placements of the first segmented object and the second segmented object based on the ground corner points of the first segmented object and the second segmented object include: grouping data related to the ground corner points including the determined distances of each of the determined ground corner points to the camera level and classifications of the determined ground corner points; associating the data to the first segmented object and the second segmented object; and storing the associated data in a database of the electronic device.

The method may further include: locating corner points of the first segmented object and the second segmented object; determining intersection points of the located corner points with the ground mesh; calculating distances of each intersection point to the camera level; and determining relative positions of the first segmented object and the second segmented objected based on the calculated distances.

According to one or more example embodiments, an electronic device for determining a relative position of at least one object in an image, may include: a display; at least one processor; and memory storing instructions that, when executed by the at least one processor, cause the at least one processor to: obtain at least one semantic parameter associated with the image; segment the at least one object based on the at least one semantic parameter to generate a first segmented object and a second segmented object; identify a camera level of the electronic device; apply a ground mesh to the image based on the camera level; determine placements of the first segmented object and the second segmented object based on the at least one semantic parameter associated with the first segmented object, the second segmented object, and the ground mesh; determine a relative position of the first segmented object with respect to the second segmented object based on the determined placement of the first segmented object and the second segmented object; and control the display to display the at least one object based on the determined relative position.

The instructions may further cause the at least one processor to: determine at least one optimal location for at least one virtual object in the image based on the determined relative position of the first segmented object with respect to the second segmented object; and control the display to display the at least one object with the at least one virtual object on a screen of the electronic device based on the determined at least one optimal location.

The at least one semantic parameter may include at least one of: the at least one object within the image, an edge of the at least one object, a ground corner point of the at least one object, a boundary of the at least one object, or a ground intersection edge of the at least one object.

The instructions may further cause the at least one processor to: determine ground corner points of the first segmented object and the second segmented object based on ground intersection edges of the first segmented object and the second segmented object; determine distances of the determined ground corner points to the camera level based on the ground mesh and the camera level; classify the determined ground corner points as at least one of a near-ground corner point, a mid-ground corner point, or a far-ground corner point; and determine the placements of the first segmented object and the second segmented object based on the determined distances and the classified ground corner points.

The instructions may further cause the at least one processor to: compare a distance of a near-ground corner point of the first segmented object with a distance of a near-ground corner point of the second segmented object; or compare a distance of a far-ground corner point of the first segmented object with a distance of a far-ground corner point of the second segmented object.

According to at least one example embodiment, an electronic device for determining a relative position of at least one object in an image, may include: a display; at least one processor; and memory storing instructions that, when executed by the at least one processor, cause the at least one processor to: identify a near object and a far object in the image; identify a camera level of the electronic device; apply a ground mesh to the image based on the camera level, the ground mesh including ground slope information; determine a first ground point of the near object and a second ground point of the far object based on ground intersection edges of the near object and the far object; determine placements of the near object and the far object based on the first ground point, the second ground point, and the ground mesh; determine the relative position of the near object with respect to the far object based on the determined placement of the near object and the far object; and control the display to display the near object and the far object based on the determined relative position.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an electronic device for determining a relative position of one or more objects in an image, according to one or more embodiments as disclosed herein;

FIG. 2 is a flow diagram illustrating a method for determining the relative position of the one or more objects in the image, according to one or more embodiments as disclosed herein;

FIG. 3 illustrates an example scenario for identifying an Object vanishing point (OVP) associated with the one or more objects in the image, according to one or more embodiments as disclosed herein;

FIG. 4A illustrates an example scenario for identifying a corner point(s) or an intersection point(s) between one or more objects and ground in the image, as well as a horizon level/camera eye level for depth order, according to one or more embodiments disclosed herein;

FIG. 4B illustrates an example scenario for identifying a corner point(s) or an intersection point(s) between one or more objects and ground in the image, as well as a horizon level/camera eye level for depth order, according to one or more embodiments disclosed herein;

FIG. 4C illustrates an example scenario for identifying a corner point(s) or an intersection point(s) between one or more objects and ground in the image, as well as a horizon level/camera eye level for depth order, according to one or more embodiments disclosed herein;

FIG. 5A illustrates an example scenario for identifying near and far points based on the respective object-ground intersection from the camera level in an absence or presence of slope information associated with the one or more objects in the image, according to one or more embodiments as disclosed herein;

FIG. 5B illustrates an example scenario for identifying near and far points based on the respective object-ground intersection from the camera level in an absence or presence of slope information associated with the one or more objects in the image, according to one or more embodiments as disclosed herein;

FIG. 5C illustrates an example scenario for identifying near and far points based on the respective object-ground intersection from the camera level in an absence or presence of slope information associated with the one or more objects in the image, according to one or more embodiments as disclosed herein;

FIG. 5D illustrates an example scenario for identifying near and far points based on the respective object-ground intersection from the camera level in an absence or presence of slope information associated with the one or more objects in the image, according to one or more embodiments as disclosed herein;

FIG. 6 illustrates an example scenario for grouping metadata/the one or more objects in the image based on depth level information, according to one or more embodiments as disclosed herein;

FIG. 7A illustrates an example scenario for layering associated with the one or more objects in the image, according to one or more embodiments as disclosed herein;

FIG. 7B illustrates an example scenario for layering associated with the one or more objects in the image, according to one or more embodiments as disclosed herein;

FIG. 8 illustrates an example scenario for layering for real-time object occlusion of the one or more objects in the image, according to one or more embodiments as disclosed herein;

FIG. 9A illustrates an example scenario for creating contextual content of the one or more objects in the image and erasing the one or more objects in the image, according to one or more embodiments as disclosed herein;

FIG. 9B illustrates an example scenario for creating contextual content of the one or more objects in the image and erasing the one or more objects in the image, according to one or more embodiments as disclosed herein;

FIG. 10 illustrates a mechanism to determine depth range information associated with the one or more objects in the image and erasing the one or more objects in the image, according to one or more embodiments as disclosed herein; and

FIG. 11 illustrates an example scenario for determining the slope information associated with the one or more objects in the image, according to one or more embodiments as disclosed herein.

### DETAILED DESCRIPTION

Additional aspects will be set forth in part in the description which follows and, in part, will be apparent from the description, or may be learned by practice of the presented embodiments.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiment herein is to provide a method for determining a relative position of one or more objects in an image. The method includes extracting (or obtaining), by the electronic device, one or more semantic parameters associated with the image. Further, the method includes segmenting (or dividing or classifying), by the electronic device, the one or more objects using the one or more extracted semantic parameters. Further, the method includes identifying, by the electronic device, a camera eye level of the electronic device. Further, the method includes applying, by the electronic device, a ground mesh to the image based on the identified camera eye level. Further, the method includes determining, by the electronic device, a placement of each segmented object based on the one or more extracted semantic parameters associated with each segmented object and the ground mesh. Further, the method includes determining, by the electronic device, the relative position of one or more segmented objects with respect to other one or more segmented objects based on the determined placement of each segmented object.

The semantic parameter may described as a parameter or predetermined parameter.

The camera eye level may described as capture height or photographing height.

Accordingly, the embodiment herein is to provide the electronic device for determining the relative position of the one or more objects in the image. The electronic device includes an image processing controller coupled with a processor and a memory. The image processing controller extracts the one or more semantic parameters associated with the image. The image processing controller segments the one or more objects using the one or more extracted semantic parameters. The image processing controller identifies the camera eye level of the electronic device. The image processing controller applies the ground mesh to the image based on the identified camera eye level. The image processing controller determines the placement of each segmented object based on the one or more extracted semantic parameters associated with each segmented object and the ground mesh. The image processing controller determines the relative position of one or more segmented objects with respect to other one or more segmented objects based on the determined placement of each segmented object.

Unlike existing methods and systems, the proposed method enables the electronic device to determine a depth and/or relative position of an object(s) associated with an image/image frame(s) based on an understanding of object geometry in perspective without relying on an electronic device's hardware (e.g., depth sensors). As a result, the proposed method enables all electronic devices to provide AR users with a world-scale enhanced experience.

Unlike existing methods and systems, the proposed method enables the electronic device to establish layering based on the object(s)-ground vanishing point(s) and object(s)-ground contact point(s). As a result, the proposed method outperforms all other existing methods. Furthermore, the proposed method takes into account various slopes in terrain in the electronic device's field of view, extending its applicability to the world-scale scale and increasing the electronic device's efficiency/accuracy to layer the segmentation based on visual semantic understanding of ‘object geometry in perspective’ to create faux depth

For depth ordering, certain existing systems' layer segmentation is based on 2D perceptual cues and 3D surface and depth cues such as colour(color) and texture variation, pixel variation, and so on. While the proposed method layers segmentation based on the geometry of the object and the camera level. Certain existing systems also use only visible object-ground contact points, whereas the proposed method determines the relative distance between one or more objects from the camera eye level, which aids in understanding the relative positioning of the one or more objects even when all of the object-ground contact points are occluded/invisible. The proposed method collects depth information by using the object geometry and is hardware-independent.

For distant objects, certain existing systems collect depth information using depth sensors. Furthermore, certain existing systems fail to reveal several edge case scenarios, such as the consideration of multiple slopes, objects with the same depth value, and so on. The proposed method reveals several such edge case scenarios, such as the slope parameter of the ground, which can identify multiple slopes and determines the depth ordering of all the objects. Certain existing systems reveal that they are primarily concerned with near-object depth calculation, whereas the proposed method is concerned with both near and far-object depth ordering. Furthermore, the proposed method takes into account various slopes in the terrain in the field of view, extending the system's applicability to the global scale and increasing the system's efficiency/accuracy. In addition, the proposed method reveals layering or depth ordering. The proposed method describes interpreting a volume of the one or more objects or a pile of objects based on their boundaries.

The majority of existing systems rely on the hardware to achieve global scale. However, even these electronic devices/existing electronic devices are limited in their ability to measure distances beyond a certain threshold. Cost, device volume, affordability, design, and so on are all reduced because the proposed method creates faux depth solely through visuals. Furthermore, the proposed method also works in real-time on static images and videos.

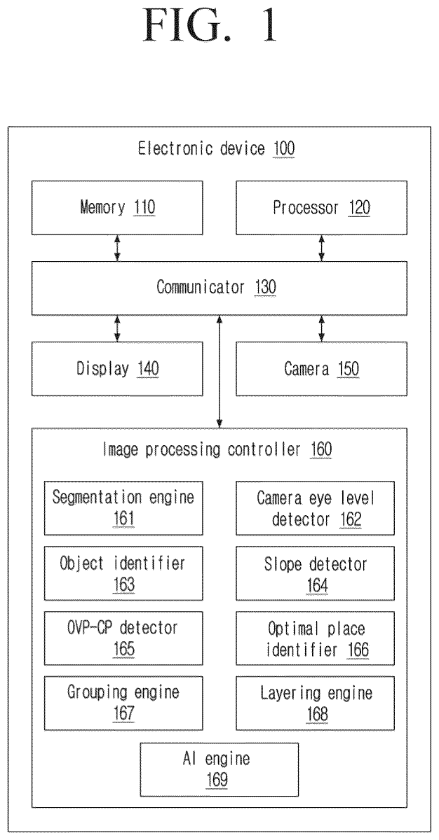

Referring now to the drawings and more particularly to FIGS. 1 through 11, where similar reference characters denote corresponding features consistently throughout the figures, there are shown preferred embodiments.

FIG. 1 illustrates a block diagram of an electronic device (100) for determining a relative position of one or more objects in an image, according to one or more embodiments as disclosed herein. The electronic device (100) can be, for example, but is not limited to a smartphone, a laptop, a desktop, a smartwatch, a smart TV, an Augmented Reality device (AR device), a Virtual Reality device (VR device), Internet of Things (IoT) device or a like.

In one or more embodiments, the electronic device (100) includes a memory (110), a processor (120), a communicator (130), a display (140), a camera (150), and an image processing controller (160).

In one or more embodiments, the memory (110) stores one or more semantic parameters associated with an image(s), a camera eye level, a ground mesh, placement information of each segmented object associated with the image(s), a relative position of one or more segmented objects with respect to other one or more segmented objects, a distance of each of the determined ground corner point to the camera eye level, a distance of near-ground corner point, a distance of a far-ground corner point, and group data. The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the electronic device (100), a cloud storage, or any other type of external storage.

The processor (120) communicates with the memory (110), the communicator (130), the display (140), the camera (150), and the image processing controller (160). The camera (150) includes one or more cameras/camera sensors to capture the image frame(s). The processor (120) is configured to execute instructions stored in the memory (110) and to perform various processes. The processor (120) may include one or a plurality of processors, maybe a general-purpose processor, such as a Central Processing Unit (CPU), an Application Processor (AP), or the like, a Graphics-only Processing Unit such as a graphics processing unit (GPU), a Visual Processing Unit (VPU), and/or an Artificial Intelligence (AI) dedicated processor such as a Neural Processing Unit (NPU).

The communicator (130) is configured for communicating internally between internal hardware components and with external devices (e.g. server) via one or more networks (e.g. Radio technology). The communicator (130) includes an electronic circuit specific to a standard that enables wired or wireless communication.

The display (140) can be a Liquid Crystal Display (LCD), a Light Emitting Diode (LED), an Organic Light-Emitting Diode (OLED), or another type of display that can also accept user inputs. Touch, swipe, drag, gesture, voice command, and other user inputs are examples of user inputs.

The image processing controller (160) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the image processing controller (160) includes a segmentation engine (161), a camera eye level detector (162), an object identifier (163), a slope detector (164), an OVP-CP detector (165), an optimal place identifier (166), a grouping engine (167), and a layering engine (168).

The segmentation engine (161) receives the one or more images from the camera (150) and uses any/conventional semantic segmentation technique to segment the one or more objects using the one or more extracted semantic parameters, where the object identifier (163) extracts the one or more semantic parameters associated with the image. The one or more semantic parameters comprise at least one of the one or more objects within the image, one or more edges of the one or more objects, one or more ground corner points of the one or more objects, one or more boundaries of the one or more objects, or one or more ground intersection edges of the one or more objects.

The camera eye level detector (162) identifies a camera eye level of the electronic device. The camera eye level also represents the camera's (150) height above the ground. Once the camera eye level detector (162) has identified the camera eye level, the camera eye level detector (162) adds a perspective ground mesh. The perspective ground mesh serves as a reference mesh for the image processing controller (160), which layers the segmentation on top of it. The slope detector (164) determines whether the slope is present in the received image(s). The OVP-CP detector (165) identifies an object vanishing point (OVP) and a camera perspective point (CP). The OVP-CP detector (165) identifies the OVP based on the object-ground point intersection of the respective slopes and projects the multiple slope data onto the perspective ground mesh. The OVP-CP detector (165) applies the ground mesh covering an area of the image below the camera eye level.

The optimal place identifier (166) determines the one or more ground corner points of the segmented object the one or more segmented objects using one or more ground intersection edges of the segmented object. The optimal place identifier (166) determines a distance of each of the determined ground corner points to the camera eye level using the ground mesh and the camera eye level. The optimal place identifier (166) classifies each of the determined ground corner points as at least one of a near-ground corner point, a mid-ground corner point, or a far-ground corner point. The optimal place identifier (166) determines the placement of each segmented object based on the distance and the classification.

In some embodiments, the at least one object comprises a near object and a far object. In some embodiments, the at least one segmented object comprises a first segmented object and a second segmented object.

The optimal place identifier (166) compares a distance of a near-ground corner point of the segmented object with the distance of the near-ground corner point of the other one or more segmented objects or compares a distance of a far-ground corner point of the segmented object with the distance of the far-ground corner point of the other one or more segmented objects to determine the relative position of one or more segmented objects with respect to the other one or more segmented objects based on the determined placement of each segmented object.

The grouping engine (167) groups' data related to the one or more ground corner points comprising the determined distance of each of the determined ground corner points to the camera eye level and a classification of each of the determined ground corner points. The grouping engine (167) associates the ground corner points data to the segmented object and stores information associated with the association in a database (i.e. memory (110)) of the electronic device (100).

The layering engine (168) layers segmented elements by using the parameters for individual segments. Once the grouping is done, the layering engine (168) gets an accurate layering of the segmentations satisfying several edge case scenarios resulting in a realistic depth as per real-world data. The layering engine (168) determines one or more optimal locations for one or more virtual objects in the image based on the determined relative position of one or more segmented objects with respect to the other one or more segmented objects. The layering engine (168) displays the one or more objects with the one or more virtual objects on a screen (i.e. display (140)) of the electronic device (100) based on the determined one or more optimal locations.

A function associated with the AI engine (169) (or ML model) may be performed through the non-volatile memory, the volatile memory, and the processor (120). One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI engine (169) of the desired characteristic is made. The learning may be performed in a device itself in which AI according to one or more embodiments is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI engine (169) may consist of a plurality of neural network layers. Each layer has a plurality of weight values and performs a layer operation through a calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and Deep Q-Networks.

Although the FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined to perform the same or substantially similar functions for determining the relative position of one or more objects in the image.

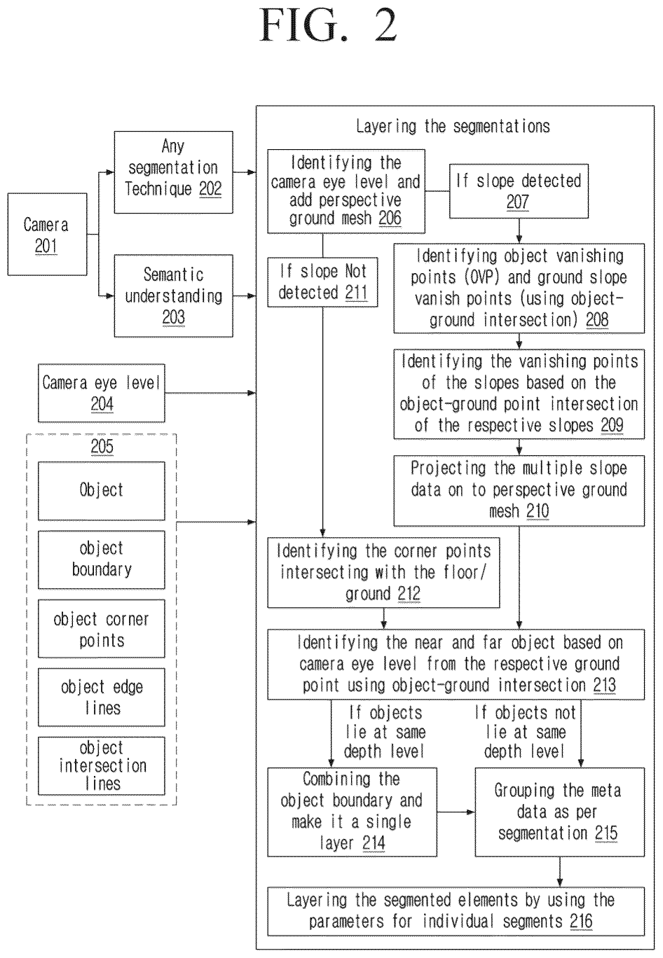

FIG. 2 is a flow diagram (200) illustrating a method for determining the relative position of the one or more objects in the image, according to one or more embodiments as disclosed herein.

The proposed method focuses on segmentation layering. To obtain realistic depth ordering, the proposed method uses any semantic segmentation technique (202) and layers those segmentations. Certain things are required in order to layer, as shown in the flow diagram (200). For example, the proposed method does not require camera height; the camera (201) only needs to understand a horizon level/camera eye level (204). Semantic understanding (203) and semantic segmentation (202) can be distinct techniques or components of the same. Semantic understanding (203) is typically a component of semantic segmentation. The proposed method requires the following from semantic understanding, identification of the camera eye level (204), object information (e.g., objects, object boundary, object corner points, object edge lines, object intersection lines, etc.) and segmentations information (202 and 203). Once the proposed method meets these basic requirements, it can move on to layering the segmentations.

At step 206, the method includes identifying, by the camera eye level detector (162), the camera eye level. In other words, the camera's eyes are looking straight ahead. The camera eye level also represents the camera's (150) height above the ground. Once the camera eye level detector (162) has identified the camera eye level, the camera eye level detector (162) adds a perspective ground mesh. The perspective ground mesh serves as a reference mesh for the image processing controller (160), which layers the segmentation on top of it. In some embodiments, the ground mesh comprises ground slope information. The slope detector (164) then determines whether the slope is present (steps 207 to 210) or absent (steps 211 to 212) in the received image(s).

At step 208, the method includes identifying, by the OVP-CP detector (165), the object vanishing points (OVP) and the camera perspective point (CP).

Camera perspective point (CP): It is the vanishing point of the camera (150). It lies at the centre(center) of a Field of View (FOV) at the camera eye level.

Object vanishing point (OVP): Every object has a different vanishing point. One can identify a shift in an orientation of the one or more objects in 3D using the shift in the OVP.

At step 209, the method includes identifying the vanishing points of the slopes based on the object-ground point intersection of the respective slopes. At step 210, the method includes projecting the multiple slope data on to perspective ground mesh. Identification of the camera eye level, the OVP, and the CP occurs concurrently and as part of a single step. They are each concentrating on two distinct aspects, as mentioned above, which will be required in the following steps. If only the slopes are detected, the OVP and CP are required; otherwise, they are not required.

At step 212, the method includes identifying, by the optimal place identifier (166), the corner points (or said ground corner points) or intersection points between the object & ground when the slope is absent in the received image(s). For layering, we just need anyone object-ground intersection point but there are a few more considerations for better accuracy. At step 213, the method includes identifying, by the optimal place identifier (166), the near and far object based on the camera eye level from the respective ground point using the object-ground intersection. At step 214, the method includes combining, by the grouping engine (167), the object boundary and making it a single layer when the one or more objects lie at the same depth level. At step 215, the method includes grouping, by the grouping engine (167), the Metadata as per segmentation when the one or more objects do not lie at the same depth level. Once the layering is done, the grouping has to be done, where multiple object boundaries are grouped to avoid errors in certain edge-case scenarios. Which also helps to reduce a number of layers and increase performance and efficiency. At step 216, the method includes layering, by the layering engine (168), the segmented elements by using the parameters for individual segments. Once the grouping is done, the proposed method gets an accurate layering of the segmentations satisfying several edge case scenarios resulting in a realistic depth as per real-world data.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

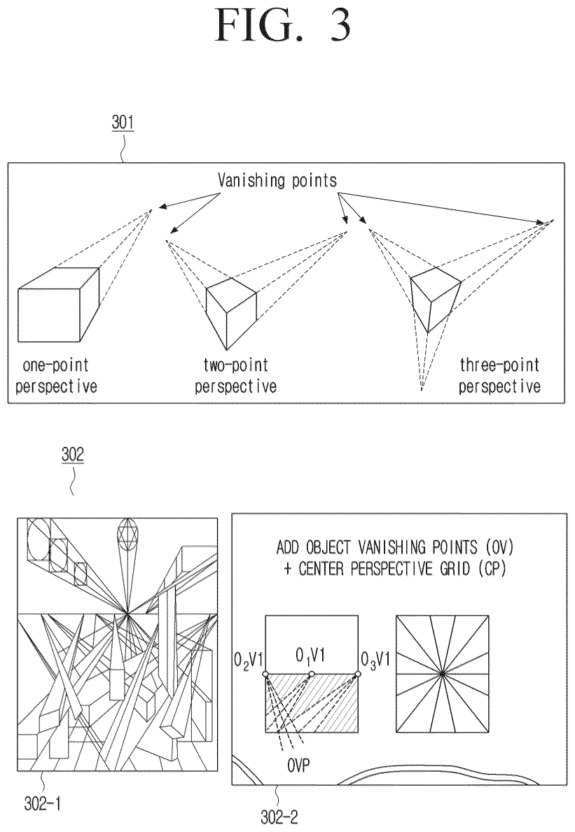

FIG. 3 illustrates an example scenario for identifying the Object vanishing point (OVP) associated with the one or more objects in the image, according to one or more embodiments as disclosed herein. The following scenarios (301 and 302) will help you identify the OVP associated with one or more objects in the image. At 301, based on the 1 point/2 point/3 point perspective the number of object perspective points for an individual object varies.

The number of object perspective points for an individual object varies depending on the 1 point/2 point/3 point perspective. Most of the time, a 1 or 2-point perspective is used, but if there is distortion due to a wide-angle lens, 3 point perspective can be used to achieve more accurate layering.

At 302-1, when the orientation of object is parallel to the camera vision, at least one object vanishing point is same as camera perspective point. When one or more objects are oriented parallel to the camera vision/eye level, at least one object's vanishing point is the same as the camera perspective point. At 302-2, all the horizontal edge object vanishing points lie at the camera eye level.

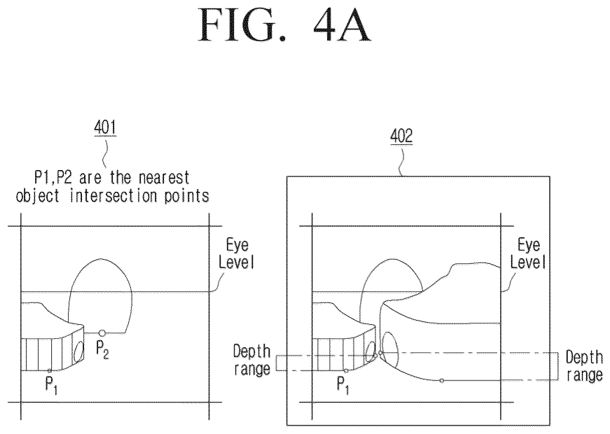

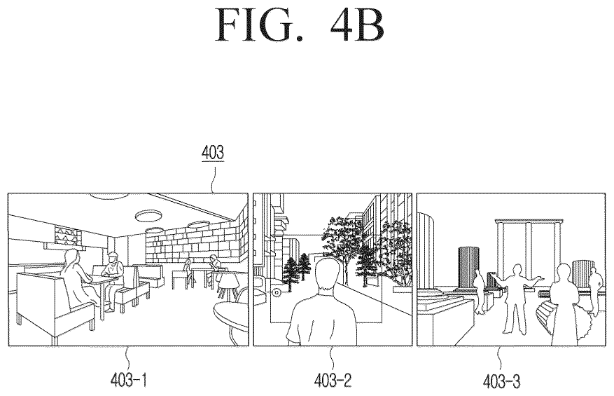

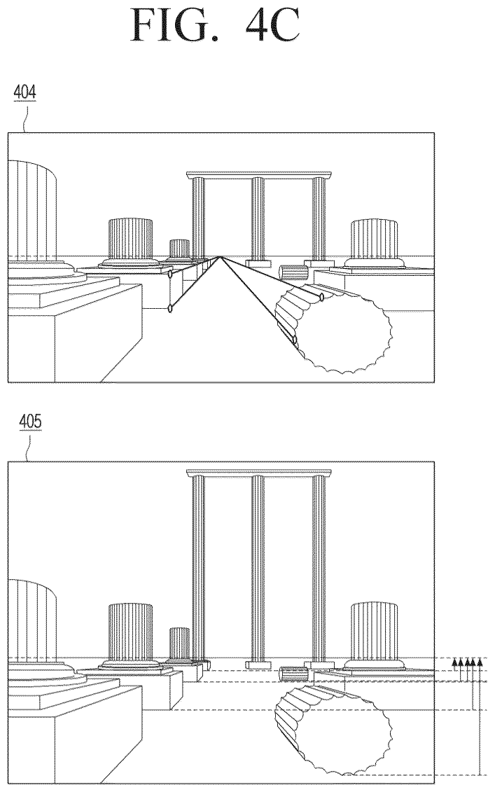

FIGS. 4A, 4B, and 4C illustrate example scenarios for identifying a corner point(s) or an intersection point(s) between one or more objects and ground in the image, as well as a horizon level/camera eye level for depth order, according to one or more embodiments disclosed herein.

Referring to FIG. 4A: At 401, the optimal place identifier (166) determines one object-ground intersection point for identifying near and far objects. It can be the intersection point nearest to/farthest from the respective ground mesh vanish point. At 402, if two objects are on the same depth level, the optimal place identifier (166) uses depth range to get a realistic occlusion of virtual objects; where the optimal place identifier (166) takes the nearest intersection point and farthest intersection point and sets them as per depth range based on visible data for both the objects. For example, the depth range can be used as an object placement constraint, and the range defines how far the virtual object can be moved in Z depth before being occluded.

Referring to FIG. 4B-4C: Horizontal level is usually at a level of the viewer's eye. The horizon level is at the centre(center) of the camera frame when the user or the camera (150) is looking straight ahead, as shown in FIG. 4B. This is how the camera eye level detector (162) detects and fixes the horizon line, the horizon level, in simple terms, divides the image frame into two equal parts. The horizon level is detected by the camera eye level detector (162) in two ways, as shown below.

Option-1 (403): initially, set the camera facing straight ahead; the scene (403-1) shows two point perspective scene. The scene (403-2) shows one point perspective with simple composition. The scene (403-3) shows one point perspective with complex composition.

The centre(center) horizontal line in the image frame/viewfinder is the horizon level.

Option-2 (404): Identify the vanishing points of 2 or more objects placed on the horizontal plane surface and connect the vanishing points using a line parallel to the edge of the image frame. This line is the horizon level as shown in the figure.

The optimal place identifier (166) only selects corner points that are visible and in contact with the ground when calculating depth ordering (405). As shown in FIG. 4C, the optimal place identifier (166) requires only one ground contact point of each object for depth ordering. The ground contact points do not have to be the actual corner points but can be any point of the surface in contact with the ground.

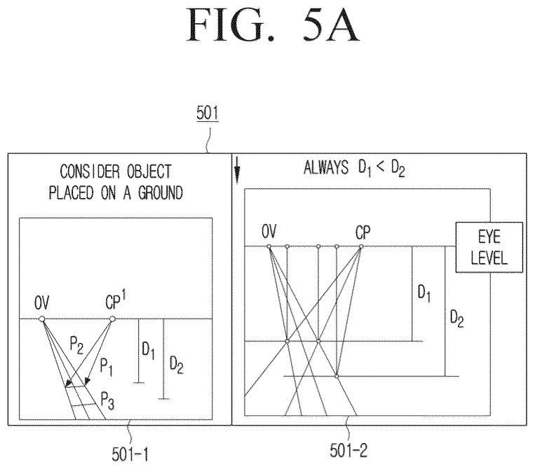

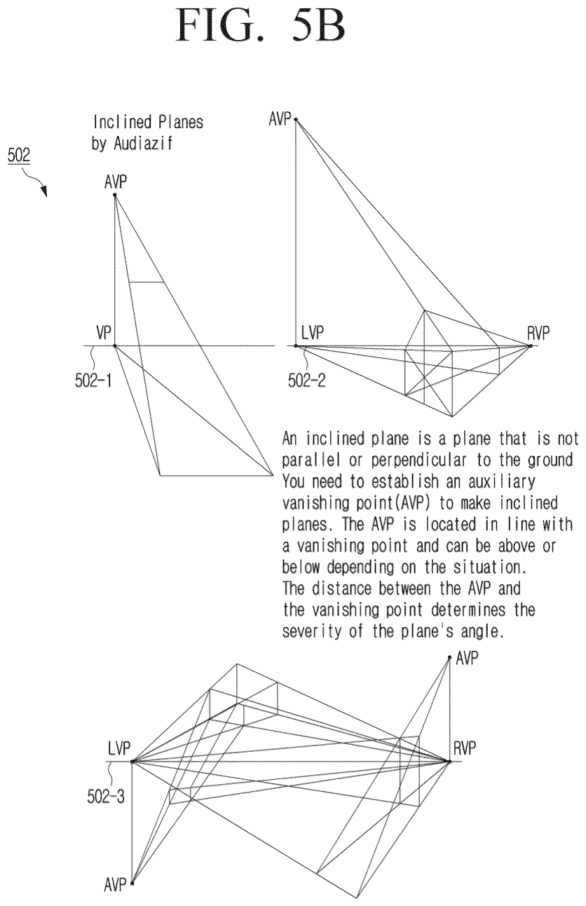

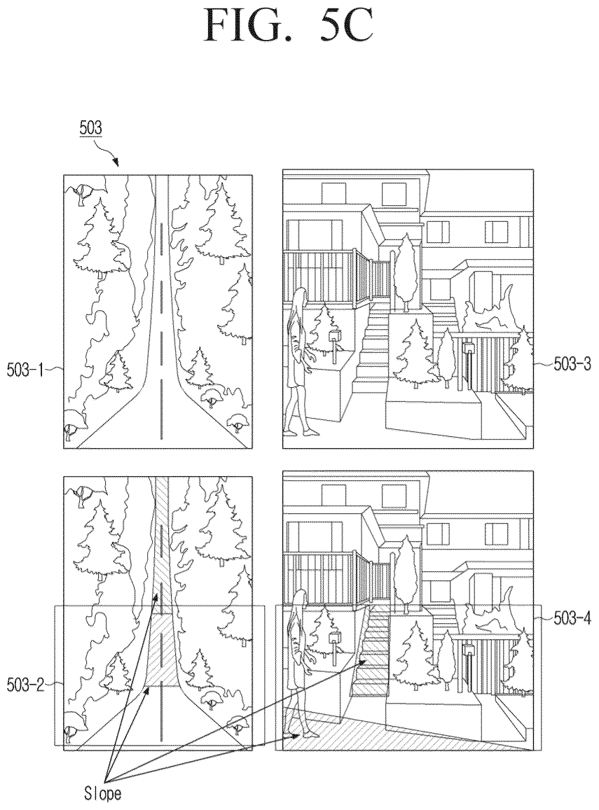

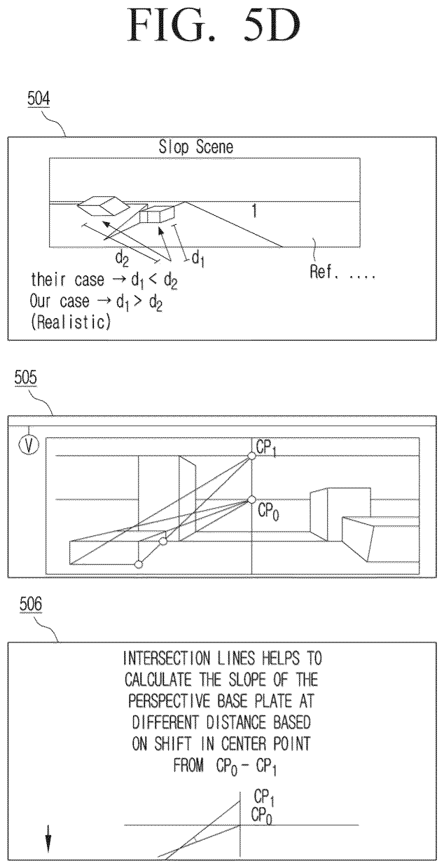

FIGS. 5A, 5B, 5C and 5D illustrate example scenarios for identifying near and far points based on the respective object-ground intersection from the camera level in an absence or presence of slope information associated with the one or more objects in the image, according to one or more embodiments as disclosed herein.

Referring to FIG. 5A: At 501-1, the optimal place identifier (166) identifies the near and far object based on the camera eye level from the respective ground point using object-ground intersection, on identifying the camera eye level. While layering the segmentations, a few factors must be considered to improve accuracy. Near and far object parameters are determined by the perpendicular distance between the object-ground intersection point and the eye level. If the intersection of the object(s) and the ground is far from the camera's eye level, it is closer to the camera (150), and vice versa. As shown in FIG. 5A, at 501-2, D1 is closer to the camera eye level than D2, implying that D2 is greater than D1. As a result, the layering must be done in such a way that D2 is in front, close to the camera, and D1 is behind, far away.

Referring to FIG. 5B and 5C: If the object(s) is inclined or the ground/floor is sloped, the vanishing points of those surfaces/objects are shifted above/below the camera eye level. This concept aids in the realistic layering of objects positioned on sloped surfaces. It is clear from FIG. 5B and 5C that the realistic scenarios have multiple slopes (502 and 503).

At 502, an example of converting complex geometry in realistic scenario into a simple geometry and defining vanishing point is shown. The sub-images 502-1, 502-2 & 502-3 combined as single image (502): Example of converting complex geometry in realistic scenario into a simple geometry and defining vanishing point.

The sub-image 503-1 and 503-3 is combine as 503-1 a real life scenario is simplified into simpler geometry. The sub-images 503-2 and 503-4 combine as 503-2 a simplified geometry identified.

Ignoring them would result in significant false layering of segmentation because the slope vanishing point is either above or below the camera eye level depending on the slope angle.

Referring to FIG. 5D: At 504, shows the false layering issue between ‘object placed on sloped ground’ and ‘object placed on non-sloped ground’. In reality, d1>d2, which can be achieved by the proposed method/the optimal place identifier (166) of individually determining, by the slope detector (164), the different slopes by its objects ground point intersection and projecting on to the ground mesh to compare the layer distance. If we don't consider the contours/slopes/elevation of the object from the ground mesh and just try to visually interpret based on colour(color)/texture/shades, this error (d1<d2) is most likely to happen. At 505, shows that the proposed method determines the vanishing point of the slope using the object ground point intersection At 506, shows that the proposed determines the slope angle based on the shift in centre(center) point of the sloped ground (CP1) from the camera eye level ground mesh centre(center) point (CP0) from the ground point intersection.

Furthermore, the proposed method uses any sloped ground mesh as reference mesh which can project the other mesh data to determine the layering. But, the camera eye level ground mesh is the ideal ref plane as it is easy to identify without any calculations. Furthermore, if there aren't any extra ground slopes identified or if there is one ground mesh that is sloped, then the proposed method can directly determine using that single mesh and deduct the steps to project onto the reference camera eye level ground mesh.

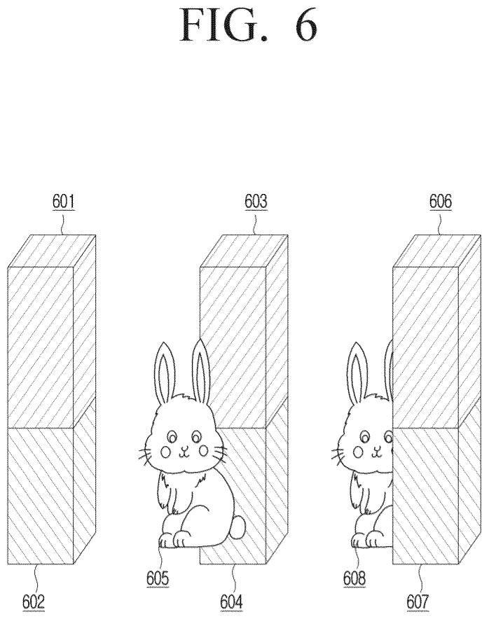

FIG. 6 illustrates an example scenario for grouping metadata/the one or more objects in the image based on depth-level information, according to one or more embodiments as disclosed herein.

The grouping engine (167) combines the object boundary and makes it the single layer when the one or more objects lie at the same depth level. The grouping engine (167) groups the Metadata as per segmentation when the one or more objects do not lie at the same depth level. Once the layering is done, the grouping has to be done, where multiple object boundaries are grouped to avoid errors in certain edge-case scenarios, shown below. Which also helps to reduce the number of layers and increase performance and efficiency.

Where 2 completely different objects are placed one above the other

Two objects (601 and 602) are placed one above the other;

If the object occlusion boundaries are not grouped (603 and 604), there is a glitch where a virtual object (605) is placed between the identified object (603 and 604);

In realistic scenarios, both the objects (606 and 607) are treated as one, for occluding the virtual object (608). In the proposed method, the grouping engine (167) groups the metadata so that such scenarios are handled well.

Where 2 objects are placed side by side at an equal distance from the camera.

Where multiple objects are at the same depth level from the user.

For all the above scenarios, all the respective objects on the same depth level are to be grouped into one single occlusion boundary layer. Furthermore, the proposed method can have the depth range value based on use cases. The layering engine (168) layers the segmented elements by using the parameters for individual segments. Once the grouping is done, the proposed method gets an accurate layering of the segmentations satisfying several edge case scenarios resulting in a realistic depth as per real-world data. All measurements are based on a 2D visual interpretation of the 3D world and distance calculation. As an example: In engineering drawing, we interpret and draw perspective drawings of objects based on their plan and elevation. We are reverse engineering the concept, attempting to comprehend the 3D perspective image and interpret its floor plan and elevation on our own. This gives us the object's relative distance.

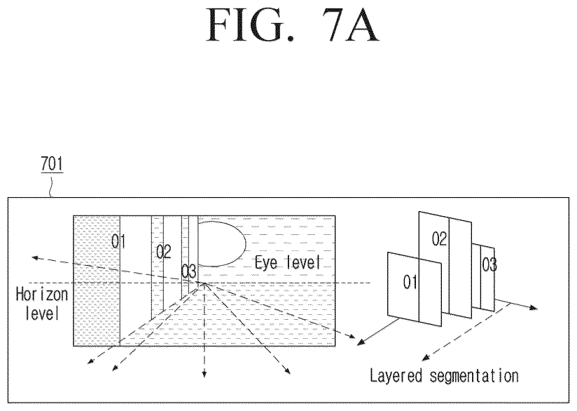

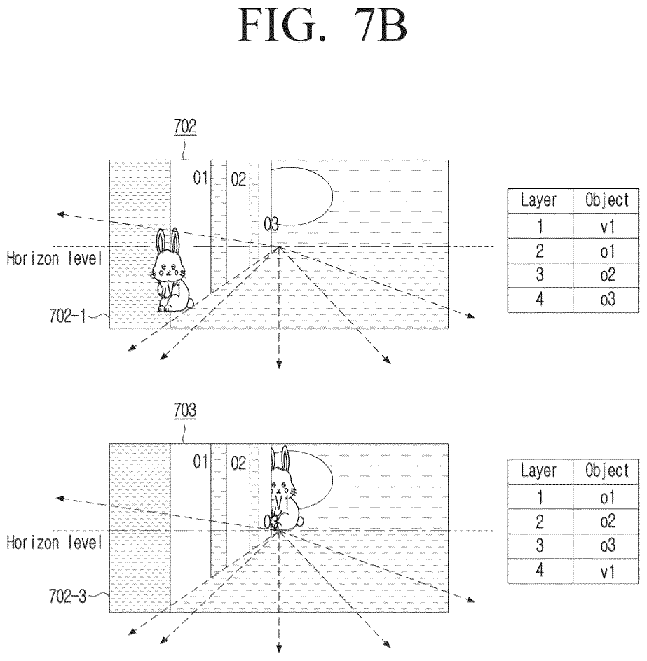

FIGS. 7A and 7B illustrate example scenarios for layering associated with the one or more objects in the image, according to one or more embodiments as disclosed herein.

Referring to FIG. 7A: At 701, represents a visual interpretation of an outcome will be similar to the FIG. 7A. According to real-world understanding, the proposed method layers the 2D visual segmentation. As a result, segmentation will be layered in 2D. As a result, it aids in creating the illusion of depth. Because the proposed method does not perform depth calculations, it cannot provide depth measurements. Once the objects have been segmented using a known methodology, they are organized into layers. When a new virtual object is added, it is placed between the existing layers and masked out with a segmentation object profile to create an occlusion effect. When the user moves the virtual object in Z-depth (along the Z-axis), the virtual object layer changes the order and is masked by the front object.

Referring to FIG. 7B: At 702-1: If the object occlusion boundaries are not grouped, you can see such glitch where virtual objects are placed between identified object. Here, O1, O2, and O3 indicate objects in the real world. V1 indicates a virtual augmented AR object. To make the virtual object move from the front to back, simply change the layer position and mask the object with the above layers segmentation object profile to create occlusion. Thus, when a virtual object is added to an image frame in the first FIG. 702), the proposed method defines the layers as V1 in layer 1, O1 in layer 2, O2 in layer 3, and O3 in layer 4. At 702-3: In realistic scenarios, both the objects are treated as one, for occluding the virtual object. In our proposed method, we group the metadata so that such scenarios are handled well. The proposed method, however, switches (703) the layer as O1 in layer 1, O2 in layer 2, O3 in layer 3, and V1 in layer 4 as the user moves the virtual object in the Z-depth. This is the proposed method for layering segmentations to obstruct virtual objects.

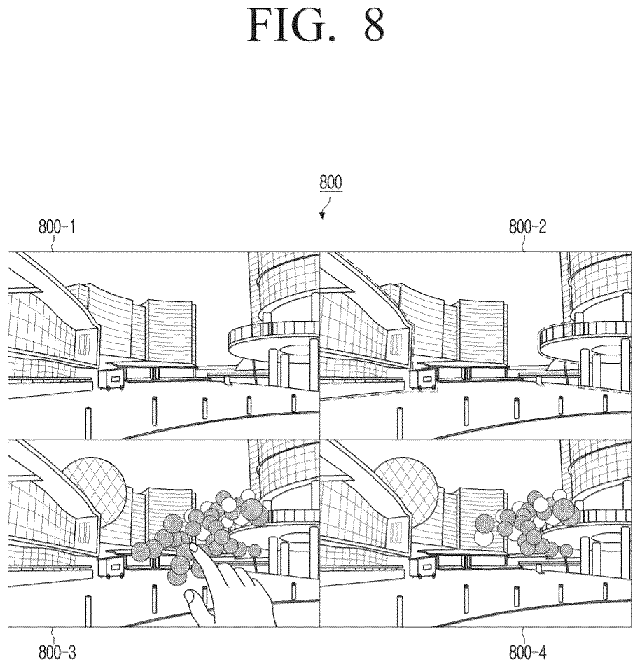

FIG. 8 illustrates an example scenario for layering for real-time object occlusion of the one or more objects in the image, according to one or more embodiments as disclosed herein. The image (800-1) illustrates a real life scene. The image (800-2) illustrates a semantic layer segmentation. The image (800-3) illustrates an AR Objects placed. The image (800-4) illustrates when an occlusion applied Objects placed.

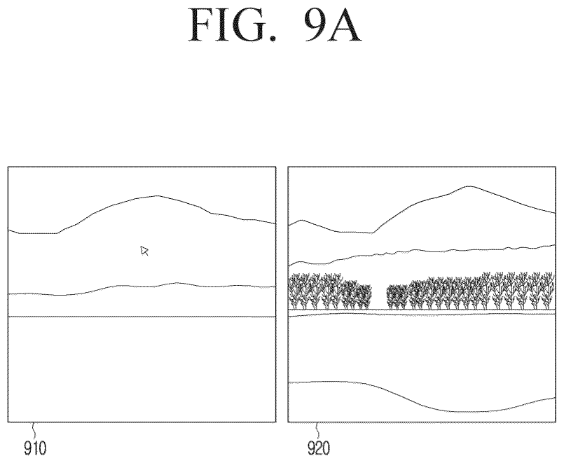

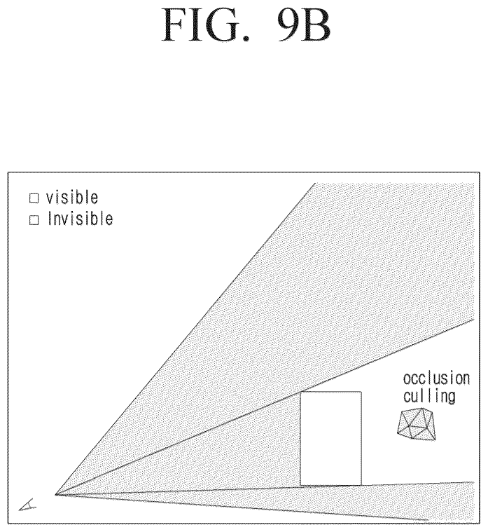

FIGS. 9A and 9B illustrate example scenarios for creating contextual content of the one or more objects in the image and erasing the one or more objects in the image, according to one or more embodiments as disclosed herein.

Referring to FIG. 9A: represents the creation of contextual content. Using the layer data, the proposed method understands the depth and, using the object occlusion boundary shape, reinterprets the visual and creates a new visual that is aligned to that boundary constraint with respect to any set context.

The sub-image 910, illustrates a Layered segmentation. The sub-image 920, illustrates a Layered segmentation with visual interpretation.

Referring to FIG. 9B: represents erasing the one or more objects in the image. Using layer segmentation boundary data, the proposed method removes the unnecessary object(s) from the preview in real-time. Layered segmentation can also be used for virtual object occlusion culling, which improves performance. The depth and segmentation-based static and video effects can be applied in-camera preview or editing based on scene layering (e.g.: dolly effect, parallax, multiple layer frame rates, background effects, etc.). The application can be used for video editing or AR experiences, where the user can layer and add Visual effects (VFX) and animation overlaid in the real world. Large-scale real-virtual interaction using layer segmentation.

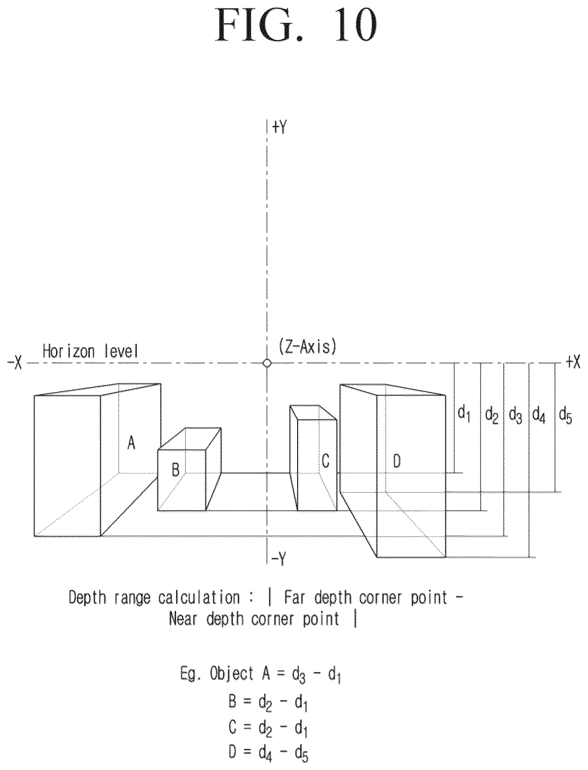

FIG. 10 illustrates a mechanism to determine depth range information associated with the one or more objects in the image and erasing the one or more objects in the image, according to one or more embodiments as disclosed herein.

To understand the depth range information consider the example where four objects with varying depth ranges are drawn. Objects B and C are of the same depth range in this case. Objects A, B, and C have far-ground contact points in common. The occlusion order is determined by the object closest to the Y plane. That is, a virtual object will be obscured first by objects near the Y axis. For example,

Object B is near to the Y axis than object A so, the virtual object first should be occluded by object B followed by Object A.

In the case of objects with no common ground contact points like Objects C & D:

Objects near to Y plane are considered first as a priority same as above.

Far-ground contact points are to be considered for depth ordering. In our case, Object D's far ground contact point d5 is far from X-axis, and Object C's far ground contact point d1 is near to the X-axis. Hence, when we are moving a virtual object in z-depth (along the Z-axis), it can be occluded by Object C first and when the object enters the d5 zone, only then does the virtual object get occluded by Object D.

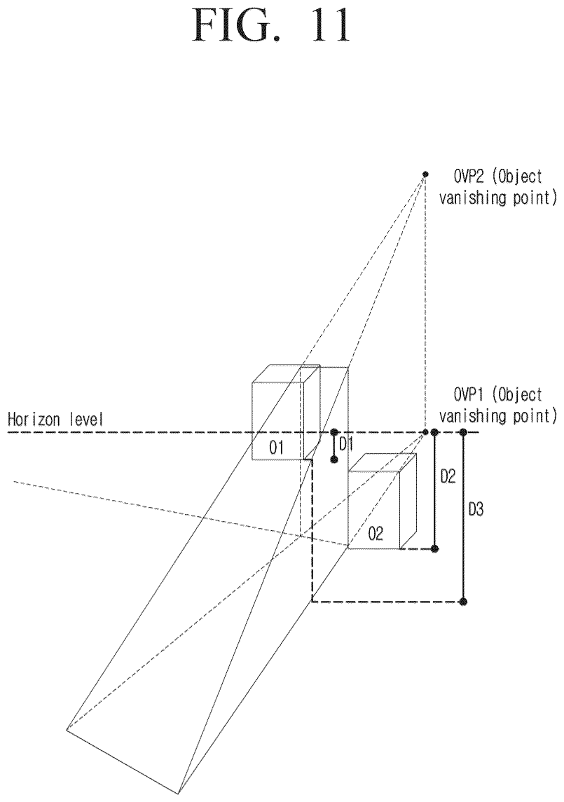

FIG. 11 illustrates an example scenario for determining the slope information associated with the one or more objects in the image, according to one or more embodiments as disclosed herein. The proposed method for depth order is to determine the distance of corner points from the horizon level. The less the distance, the farther away is the corner point from the camera (D1<D2<D3), and in turn the farther is the object from the camera. When the one or more objects are placed on a ground surface, we calculate the distance from the corner points to the horizon level for depth ordering. However, when the object is placed on a sloped surface (as shown in fig.), if we don't consider the slope and directly calculate the depth from the elevated height, the corner point will be close to the horizon level (D1). Hence, it will show an error as D1<D2 i.e., O1 is farther than O2. But in reality O2>O1. In order to solve this error, using object vanishing points we are trying to understand the object geometry like the slope as shown, based on which we are projecting the contact point of O1 onto the ground to attain its original distance from the horizon level, D3. D3>D2. Therefore, O2 is farther away than O1.

In one embodiment, the proposed method has several advantages, which are listed below.

The proposed method also applies to monocular vision.

The proposed method simply layering 2D visual segmentation based on real-world understanding. As a result, segmentation will be layered in 2D. As a result, it aids us in creating the illusion of depth.

Unlike other existing methods, the proposed method identifies different sloped ground surfaces and layers the object boundaries according to the sloped surface, resulting in a realistic layered segmentation.

Because the proposed method only uses camera visuals and semantic understanding, mobile AR can now be taken to a global scale.

There is no reliance on hardware, such as a depth sensor, to generate depth.

There is no need for depth parameters when creating depth.

Improve the immersive experience.

The proposed method works on any device that has a camera.

The proposed method controls performance by using layer data to control the frame rate of individual virtual objects.

Less bulky hardware.

Cost savings.

Images that are both real-time and static.

The proposed method determines the distance between two objects.

Occlusion culling using layered segmentation improves performance.

In one embodiment, to perform layered segmentation in a real-world context, one must know the relative distance between objects, which requires the use of depth sensors to calculate the distance. However, not all devices are equipped with depth sensors. Even with depth sensors, there is a limit to how far you can go. Aside from that, the depth sensor rarely works. As a result, taking AR experiences to a global scale on phones or any other device with/without depth sensors has become difficult. The proposed layered segmentation understands the world perspective guidelines and positions the segmentation in various layers as a result. It can take AR experiences to a global scale without the use of depth sensors because it is not calculate distance and is only attempting to understand the visuals based on our guidelines. As a result, it works on any device that has the camera.

In one embodiment, all known segmentation layering is done primarily based on understanding segmentation cues such as object intersections, occluded object understanding, texture understanding, material shade variation, and so on, whereas the proposed layered determines depth based on an understanding of object geometry in perspective. Unlike other ideas, the proposed layered identifies different sloped ground surfaces and layers the object boundaries according to the sloped surface, resulting in a realistic layered segmentation.

In one embodiment, the proposed method achieves layered segmentation without a TOF/Depth sensor using this method. This enables layered segmentation concepts to be enabled in lower-end devices and works well with any other device that has a camera (VST, AR glasses, smart watches, TV, etc.,) Advantages: less bulky hardware, lower cost, works in any device with the camera and brings AR to the global stage. Rendering has a significant impact on performance. The proposed method applies different frame rates to different virtual objects based on the depth data we generate. Multiple virtual objects can have different frame rates, and each frame rate can be adjusted using our layered segmentation data. As a result, the performance rate is significantly increased. Many software-based solutions analyze every frame in real time for segmentation and even layer the segmentation, but in the proposed method, because the proposed method determines the relative distance between objects, the calculation happens only once and the layered properties are added to all objects, drastically reducing performance. If a new object enters the FOV, it only needs to calculate its distance from any other object in the real world and adjust the layering.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method of controlling an electronic device for determining a relative position of at least one object in an image, the method comprising:
obtaining at least one semantic parameter associated with the image;
segmenting the at least one object based on the at least one semantic parameter to generate a first segmented object and a second segmented object;
identifying a camera level of the electronic device;
applying a ground mesh to the image based on the camera level;
determining placements of the first segmented object and the second segmented object based on the at least one semantic parameter associated with the first segmented object, the second segmented object, and the ground mesh;
determining a relative position of the first segmented object with respect to the second segmented object based on the determined placement of the first segmented object and the second segmented object; and
displaying the at least one object on a screen of the electronic device based on the determined relative position.

2. The method of claim 1, further comprising:
determining at least one optimal location for at least one virtual object in the image based on the determined relative position of the first segmented object with respect to the second segmented object; and
displaying the at least one object with the at least one virtual object on the screen of the electronic device based on the determined at least one optimal location.

3. The method of claim 1, wherein the at least one semantic parameter comprises at least one of: the at least one object within the image, an edge of the at least one object, a ground corner point of the at least one object, a boundary of the at least one object, or a ground intersection edge of the at least one object.

4. The method of claim 1, wherein the determining the placements of the first segmented object and the second segmented object based on the at least one semantic parameter associated with the first segmented object, the second segmented object, and the ground mesh comprises:
determining ground corner points of the first segmented object and the second segmented object based on ground intersection edges of the first segmented object and the second segmented object;
determining distances of the determined ground corner points to the camera level based on the ground mesh and the camera level;
classifying the determined ground corner points as at least one of a near-ground corner point, a mid-ground corner point, or a far-ground corner point; and
determining the placements of the first segmented object and the second segmented object based on the determined distances and the classified ground corner points.

5. The method of claim 1, wherein the determining the relative position of the first segmented object with respect to the second segmented object based on the determined placements of the first segmented object and the second segmented object comprises at least one of:
comparing a distance of a near-ground corner point of the first segmented object with a distance of a near-ground corner point of the second segmented object; or
comparing a distance of a far-ground corner point of the first segmented object with a distance of a far-ground corner point of the second segmented object.

6. The method of claim 1, wherein the applying the ground mesh based on the camera level comprises:
applying the ground mesh covering an area of the image below the camera level.

7. The method of claim 4, wherein the determining the distances of the determined ground corner points to the camera level based on the ground mesh and the camera level comprises:
determining the distances as perpendicular distances between the ground corner points and the camera level.

8. The method of claim 4, wherein the determining the distances of the determined ground corner points to the camera level based on the ground mesh and the camera level comprises:
locating at corner points of the first segmented object and the second segmented object;
determining intersection points of the located corner points with the ground mesh; and
determining the distances as perpendicular distances between the corner points and the camera level.

9. The method of claim 4, wherein the determining the placements of the first segmented object and the second segmented object based on the ground corner points of the first segmented object and the second segmented object comprises:
grouping data related to the ground corner points comprising the determined distances of each of the determined ground corner points to the camera level and classifications of the determined ground corner points;
associating the data to the first segmented object and the second segmented object; and
storing the associated data in a database of the electronic device.

10. The method of claim 1, further comprising:
locating corner points of the first segmented object and the second segmented object;
determining intersection points of the located corner points with the ground mesh;
calculating distances of each intersection point to the camera level; and
determining relative positions of the first segmented object and the second segmented objected based on the calculated distances.

11. An electronic device for determining a relative position of at least one object in an image, comprising:
a display; at least one processor; and
memory storing instructions that, when executed by the at least one processor, cause the at least one processor to:
obtain at least one semantic parameter associated with the image;
segment the at least one object based on the at least one semantic parameter to generate a first segmented object and a second segmented object;
identify a camera level of the electronic device;
apply a ground mesh to the image based on the camera level;
determine placements of the first segmented object and the second segmented object based on the at least one semantic parameter associated with the first segmented object, the second segmented object, and the ground mesh;
determine a relative position of the first segmented object with respect to the second segmented object based on the determined placement of the first segmented object and the second segmented object; and
control the display to display the at least one object based on the determined relative position.

12. The electronic device of claim 11,
wherein the instructions further cause the at least one processor to:
determine at least one optimal location for at least one virtual object in the image based on the determined relative position of the first segmented object with respect to the second segmented object; and
control the display to display the at least one object with the at least one virtual object on a screen of the electronic device based on the determined at least one optimal location.

13. The electronic device of claim 11, wherein the at least one semantic parameter comprises at least one of: the at least one object within the image, an edge of the at least one object, a ground corner point of the at least one object, a boundary of the at least one object, or a ground intersection edge of the at least one object.

14. The electronic device of claim 11, wherein the instructions further cause the at least one processor to:
determine ground corner points of the first segmented object and the second segmented object based on ground intersection edges of the first segmented object and the second segmented object;
determine distances of the determined ground corner points to the camera level based on the ground mesh and the camera level;
classify the determined ground corner points as at least one of a near-ground corner point, a mid-ground corner point, or a far-ground corner point; and
determine the placements of the first segmented object and the second segmented object based on the determined distances and the classified ground corner points.

15. The electronic device of claim 11, wherein the instructions further cause the at least one processor to:
compare a distance of a near-ground corner point of the first segmented object with a distance of a near-ground corner point of the second segmented object; or
compare a distance of a far-ground corner point of the first segmented object with a distance of a far-ground corner point of the second segmented object.

16. An electronic device for determining a relative position of at least one object in an image, comprising:
a display;
at least one processor; and
memory storing instructions that, when executed by the at least one processor, cause the at least one processor to:
identify a near object and a far object in the image;
identify a camera level of the electronic device;
apply a ground mesh to the image based on the camera level, the ground mesh comprising ground slope information;
determine a first ground point of the near object and a second ground point of the far object based on ground intersection edges of the near object and the far object;
determine placements of the near object and the far object based on the first ground point, the second ground point, and the ground mesh;
determine the relative position of the near object with respect to the far object based on the determined placement of the near object and the far object; and
control the display to display the near object and the far object based on the determined relative position.
